(19) United States
(12) Patent Application Publication
(10) Pub. No.: US 2026/0129684 A1
(43) Pub. Date: May 7, 2026

(54) AUTONOMOUS TRANSMISSION FOR AMBIENT INTERNET OF THINGS (AIoT) DEVICES

(71) Applicant: Lenovo (United States) Inc., Morrisville, NC (US)

(72) Inventors: Hyung-Nam CHOI, Ottobrunn (DE); Karthikeyan GANESAN, Nauheim (DE); Ali Ramadan ALI, Kraiburg am Inn (DE)

(21) Appl. No.: 18/936,856

(22) Filed: Nov. 4, 2024

(51) Int. Cl. H04W 74/0833; H04W 4/70

(52) U.S. Cl. CPC H04W 74/0833; H04W 4/70

(57) ABSTRACT

Various aspects of the present disclosure relate to methods and systems for configuring ambient IoT (AIoT) devices to transmit different types of data traffic. The methods and systems establish procedures (e.g., messaging flows) for configuring AIoT devices to perform device-originated autonomous (DO-A) type data transmissions, control the prioritization (e.g., load or access attempts) of DO-A type data transmission, introduce CBRA resource allocations and selections for DO-A type data transmissions, and identifies various methods for transmitting DO-A data.

### TECHNICAL FIELD

The present disclosure relates to wireless communications, and more specifically to autonomous transmission for ambient Internet of Things (AIoT) devices.

### BACKGROUND

A wireless communications system may include one or multiple network communication devices, which may be otherwise knowns as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Ambient power-enabled devices, such as Internet of Things (IoT) devices, or AIoT devices, include battery-less devices that have limited storage capabilities (e.g., via capacitors) or other capability restrictions. In some cases, these ambient power-enabled devices may store energy by harvesting energy from the environment, such as via radio waves, light, heat, motion, and other energy/power sources available to the devices.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that support wireless communication for AIoT devices, including autonomous device-originated communication (e.g., data transmission, data reception) for AIoT devices.

A reader device for wireless communication is described. The reader device may be configured to, capable of, or operable to perform one or more operations as described herein. For example, the reader device may comprise at least one memory and at least one processor coupled with the at least one memory and configured to cause the reader device to transmit, to an IoT device, a first message comprising a set of one or more parameters for autonomous data transmission, and receive, from the IoT device, a second message based at least in part on the transmitted first message.

A processor for wireless communication is described. The processor may be configured to, capable of, or operable to perform one or more operations as described herein. For example, the processor may comprise at least one controller coupled with at least one memory and configured to cause the processor to transmit, to an IoT device, a first message comprising a set of one or more parameters for autonomous data transmission, and receive, from the IoT device, a second message based at least in part on the transmitted first message.

A method performed or performable by a reader device is described. The method may comprise transmitting, to an IoT device, a first message comprising a set of one or more parameters for autonomous data transmission, and receiving, from the IoT device, a second message based at least in part on the transmitted first message.

In some implementations of the reader device, processor, and method described herein, the set of one or more parameters comprise a set of one or more values, and wherein each value indicates a corresponding priority associated with channel access for the IoT device during a contention-based random access (CBRA) procedure.

In some implementations of the reader device, processor, and method described herein, the set of one or more values is based at least in part on a type of data for autonomous data transmission.

In some implementations of the reader device, processor, and method described herein, the set of one or more parameters comprises a set of one or more values, and wherein each value indicates a probability for channel access for the IoT device during a CBRA procedure.

In some implementations of the reader device, processor, and method described herein, the set of one or more values are based at least in part on a type of data for autonomous data transmission.

In some implementations of the reader device, processor, and method described herein, the second message comprises an identifier of the IoT device.

Some implementations of the reader device, processor, and method described herein, the reader device, processor, and method may further be configured to, capable of, performed, performable, or operable to transmit, to the IoT device, a third message comprising scheduling information and receive, from the IoT device, a fourth message comprising information that indicates a type of collected data associated with the IoT device.

In some implementations of the reader device, processor, and method described herein, the first message comprises a configuration that indicates one or more of a first set of time resources or a first set of frequency resources for autonomous data transmissions, and one or more of a second set of time resources or a second set of frequency resources for trigger-based data transmissions.

In some implementations of the reader device, processor, and method described herein, the autonomous data transmission is a sensor-based data transmission, and a trigger-based data transmission is an inventory data transmission or a command data transmission.

Some implementations of the reader device, processor, and method described herein, the reader device, processor, and method may further be configured to, capable of, performed, performable, or operable to receive a third message from a second IoT device, wherein the second message and the third message are received concurrently.

In some implementations of the reader device, processor, and method described herein, the reader device is a UE or a base station.

A UE for wireless communication is described. The UE may be configured to, capable of, or operable to perform one or more operations as described herein. For example, the UE may comprise at least one memory and at least one processor coupled with the at least one memory and configured to cause the UE to receive, from a reader device, a first message comprising a set of one or more parameters for autonomous data transmission by the UE, determine an autonomous data transmission based on the set of one or more parameters, and transmit, to the reader device, a second message based at least in part on the received first message.

A processor for wireless communication is described. The processor may be configured to, capable of, or operable to perform one or more operations as described herein. For example, the processor may comprise at least one controller coupled with at least one memory and configured to cause the processor to receive, from a reader device, a first message comprising a set of one or more parameters for autonomous data transmission by the UE, determine an autonomous data transmission based on the set of one or more parameters, and transmit, to the reader device, a second message based at least in part on the received first message.

A method performed or performable by a UE is described. The method may comprise receiving, from a reader device, a first message comprising a set of one or more parameters for autonomous data transmission by the UE, determining an autonomous data transmission based on the set of one or more parameters, and transmitting, to the reader device, a second message based at least in part on the received first message.

In some implementations of the UE, processor, and method described herein, the set of one or more parameters comprise a set of one or more values, and wherein each value indicates a corresponding priority associated with channel access for the UE during a CBRA procedure.

In some implementations of the UE, processor, and method described herein, the set of one or more values is based at least in part on a type of data for autonomous data transmission.

In some implementations of the UE, processor, and method described herein, the set of one or more parameters comprises a set of one or more values, and where each value indicates a probability for channel access for the UE during a CBRA procedure.

In some implementations of the UE, processor, and method described herein, the set of one or more values are based at least in part on a type of data for autonomous data transmission.

In some implementations of the UE, processor, and method described herein, the UE is an AIoT device.

In some implementations of the UE, processor, and method described herein, the UE, processor, and method may further be configured to, capable of, performed, performable, or operable to collect information associated with an event at a location that contains the UE and transmit the collected information to the reader device based on an access prioritization identified by the set of one or more parameters.

### BRIEF DESCRIPTION OF THE DRAWINGS

FIG. 1 illustrates an example of a wireless communications system in accordance with aspects of the present disclosure.

FIG. 2A illustrates an example topology of an AIoT device and a reader device in accordance with aspects of the present disclosure.

FIG. 2B illustrates an example AIoT deployment in accordance with aspects of the present disclosure.

FIGS. 3 through 5 illustrate example diagrams of messaging flows that support AIoT device data transmissions in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of an NE in accordance with aspects of the present disclosure.

FIG. 9 illustrates a flowchart of a method performed by a UE or an NE in accordance with aspects of the present disclosure.

FIG. 10 illustrates a flowchart of a method performed by a UE in accordance with aspects of the present disclosure.

### DETAILED DESCRIPTION

A wireless communications system may include one or more AIoT devices, which may be a passive-IoT device, a passive radio frequency identification (RFID) tag (e.g., sticker, tag, badge, patch, or the like), and/or a passive sensor, supporting one or more functionalities (e.g., processing, monitoring, tracking, collecting, receiving, transmitting) that may be more cost-effective and low-maintenance compared to other devices. For example, an AIoT device may harvest and store energy from an environment, such as one or more of solar (e.g., via photovoltaic energy harvesting), vibration (e.g., via piezoelectric, electrostatic, or electromagnetic energy harvesting), thermal (e.g., via thermoelectric energy harvesting), or radio waves, such as radio frequency (e.g., via signals received through an antenna of the AIoT device). The AIoT device may perform one or more operations (e.g., transmission, reception, via backscattering) using the stored harvested energy.

In some examples, an AIoT device may be a passive RFID tag equipped on an entity (e.g., an object, another device) and may be configured to, capable of, or operable to track of a location of the entity using stored harvested energy. In some other examples, the AIoT device may be a sensor configured to, capable of, or operable to monitor conditions (e.g., temperature, humidity, vibration, smoke, and the like) of an environment (e.g., a location, a region, a zone) associated with the entity. The AIoT device may be configured to, capable of, or operable to collect or obtain sensor data and transmit the sensor data to a reader device (e.g., a UE or a NE) periodically or based on events.

An AIoT device may be classified according to one or more categories. A first category AIoT device may lack both energy harvesting capabilities and communication capabilities. As such, the first category AIoT device may be considered a passive device and be exclusively capable of performing backscattering operations (e.g., backscattering transmissions). A second category AIoT device may support energy harvesting capabilities but lack communication capabilities. As such, the second category AIoT device may be considered a semi-passive device and be exclusively capable of performing backscattering operations (e.g., backscattering transmissions). However, in some cases, because the second category AIoT device supports energy harvesting capabilities, the second category AIoT device may be capable of amplifying reflected signals using stored harvested energy. A third category AIoT device may be considered an active device and support both energy harvesting and communication capabilities. In this example, the third category AIoT device may be equipped with an active radio frequency circuitry to support active communication (e.g., transmission, reception of signals).

The wireless communications system may support one or more topologies and deployment scenarios, such as a first topology in which an NE (e.g., a base station or other network entity) functions as a reader device and a source of a carrier wave (e.g., for exciting an AIoT device to perform backscattering), a second topology in which a UE functions as the reader device and the source of the carrier wave, a third topology in which the NE functions as the reader device and a different device (e.g., a UE or other intermediate node) functions as the source of the carrier wave (e.g., an emitter node), a fourth topology in which the NE controls operations and other network entities (e.g., nodes) function as reader devices and/or carrier wave sources, etc.

An AIoT device may be configured to, capable of, or operable to transmit different types of data traffic based on certain use cases. The AIoT device may utilize device-originated-device-terminated triggered (DO-DTT) or device-terminated (DT) data traffic types during inventory or command use cases, for example, and may utilize a device-originated autonomous (DO-A) traffic type (e.g., autonomous device-originated data transmissions) for sensor or sensor-based use cases.

Various aspects of the present disclosure support a framework for configuring AIoT devices to transmit one or more types of data traffic. The framework supports procedures (e.g., messaging flows) for configuring AIoT devices (e.g., UEs) to perform DO-A data transmissions, for controlling prioritization (e.g., load or access attempts) of DO-A data transmission, for allocating CBRA resources, for selecting DO-A data transmissions, and for performing DO-A data transmissions. By enabling the AIoT devices to support such a framework, the AIoT devices may support different data transmission types for different command use cases, inventory use cases, sensor or data collection use cases, and other benefits. Additionally, the AIoT devices may experience reduced power consumption, more efficient utilization of resources, and son on.

Aspects of the present disclosure are described in the context of a wireless communications system.

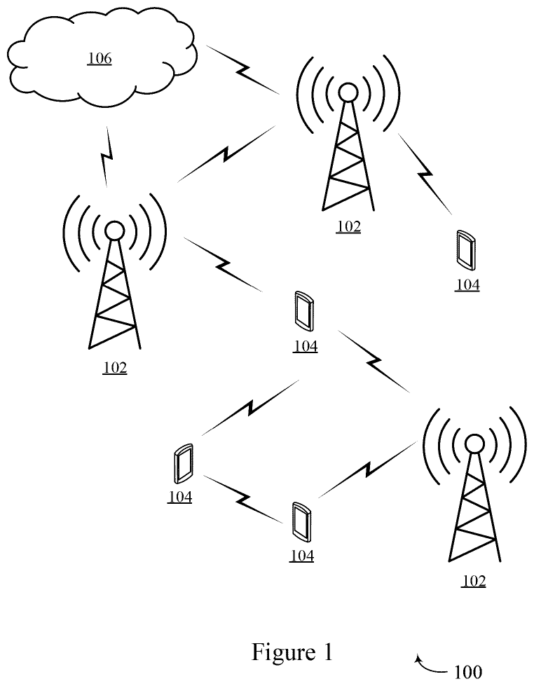

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies.

In some implementations, the wireless communications system 100 may be a 4G network, such as an LTE network or an LTE-Advanced (LTE-A) network. In some other implementations, the wireless communications system 100 may be an NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, or network interface). In some implementations, the NE 102 may communicate with each other directly. In some other implementations, the NE 102 may communicate with each other or indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signaling bearers, etc.) for the one or more UEs 104 served by the one or more NE 102 associated with the CN 106.

The CN 106 may communicate with a packet data network over one or more backhaul links (e.g., via an S1, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The wireless communications system 100 may support configuring IoT devices, such as AIoT devices, to perform data transmissions for one or more traffic types, such as DO-A data types, DO-DTT data types, DT data types, etc. In the wireless communication system 100, a base station 102 or a UE 104, which may be examples of a reader device, may transmit, to an IoT device, a first message including a set of one or more parameters for autonomous data transmission, and receive, from the IoT device, a second message based at least in part on the transmitted first message. Additionally, in the wireless communication system 100, a UE 104, which may be an example of an AIoT device may receive, from a reader device (e.g., a base station 102 or another UE 104), a first message including a set of one or more parameters for autonomous data transmission by the UE 104, determine an autonomous data transmission based on the set of one or more parameters, and transmit, to the reader device, a second message based at least in part on the received first message.

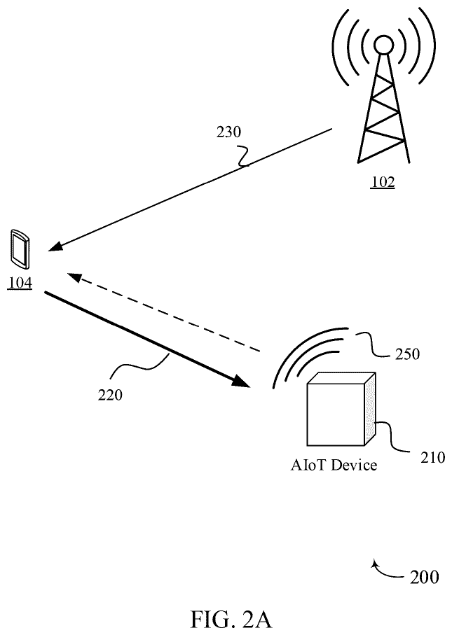

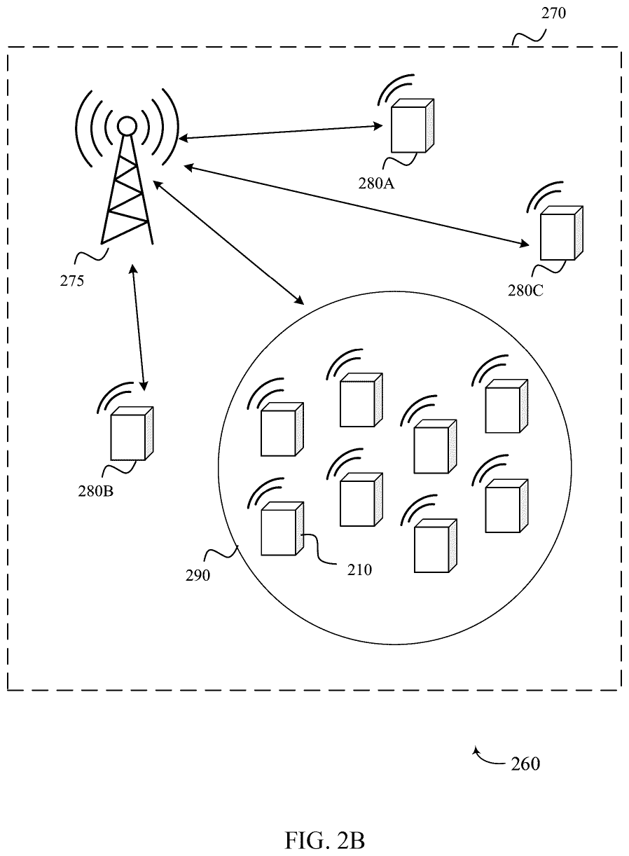

FIG. 2A illustrates an example topology 200 of an AIoT device and a reader device in accordance with aspects of the present disclosure. The topology 200 may implement or be implemented by aspects of the wireless communication system 100. For example, the topology 200 may include an NE 102 (e.g., a base station, an access point), a UE 104 (e.g., configured as or operable as an emitter node and/or a reader node), and an AIoT device 210, which be one or more examples of devices described herein with reference to FIG. 1. In the following description of the topology 200, one or more operations or signaling performed by one or more of the NE 102, the UE 104, and the AIoT device 210 may be performed or signaled (e.g., transmitted, received) in a different order than the example order shown, or the operations or signaling performed by one or more of the NE 102, the UE 104, and the AIoT device 210 may be performed or signaled (e.g., transmitted, received, backscattered) in different orders or at different times.

The NE 102 may transmit, and the UE 104 may receive, a first message 230.

The first message may be an RRC message, a downlink control information (DCI), a medium access control-control element (MAC-CE), or other example message that includes one or more of a configuration, a set of one or more parameters, a set of one or more commands for AIoT. The UE 104, in response to (or based at least in part on) the first message 230, may transmit one or more carrier waves 220 to the AIoT device 210. The one or more carrier waves 220 may excite the AIoT device 210 (e.g., enable or cause the AIoT device 210 to operate) to perform one or more backscattering transmissions 250, which are received (e.g., read, proceed, decoded) by the UE 104 (e.g., functioning as a reader device, or a reader).

The AIoT device 210 may correspond to a device type, including a first type (Type 1) (e.g., a passive device), a second type (Type 2A) (e.g., a semi-passive device), a third type (Type 2B) (e.g., an active device), etc. A Type 1 AIoT device may exhibit ˜1 μW peak power consumption, be operable to store energy, operate in accordance with an initial sampling frequency offset (SFO) up to 10^{X} ppm, and not perform (e.g., refrain from) downlink or uplink amplification. For example, a Type 1 AIoT device may perform an uplink transmission by backscattering an external carrier wave (e.g., a carrier wave 220). A Type 2A AIoT device may exhibit up to a few hundred μW peak power consumption, be operable to store energy, operate in accordance with an initial SFO up to 10^{X} ppm, and perform downlink or uplink amplification. Additionally, a Type 2A AIoT device may perform an uplink transmission by backscattering an external carrier wave (e.g., the carrier wave 220). A Type 2B AIoT device may exhibit up to a few hundred μW peak power consumption, be operable to store energy, operate in accordance with an initial SFO up to 10^{X} ppm, and perform downlink or uplink amplification. A Type 2B AIoT device may internally generate uplink transmissions (e.g., be an active device).

While the topology 200 illustrates one deployment of the AIoT device 210, other deployments are possible. For example, a deployment may include the NE 102 functioning as an emitter node and a reader (or receiver) node, a deployment may include the UE 104 functioning as an emitter node and a reader (or receiver) node, a deployment may include another NE 102 as an intermediate node (e.g., an emitter node), and so on.

FIG. 2B illustrates an example AIoT device deployment 260 in accordance with aspects of the present disclosure. The AIoT device deployment 260 may implement or be implemented by aspects of the wireless communication system 100 or the topology 200. For example, the AIoT device deployment 260 may include a reader device 275 (e.g., a base station), a first set of AIoT devices 280, and a second set of AIoT devices 290, which may be examples of devices described here with reference to FIGS. 1 and 2A. In the following description of the AIoT device deployment 260, one or more operations or signaling performed by one or more of the reader device 275, the first set of AIoT devices 280, and the second set of AIoT devices 290 may be performed or signaled (e.g., transmitted, received) in a different order than the example order shown, or the operations or signaling performed by one or more of the reader device 275, the first set of AIoT devices 280, and the second set of AIoT devices 290 may be performed or signaled (e.g., transmitted, received, backscattered) in different orders or at different times.

In the example of FIG. 2B, a location 270 (e.g., an area, a region, a zone), such as a warehouse or other indoor facility, may include multiple AIoT devices (e.g., the first set of AIoT devices 280, the second set of AIoT devices 290) served by the reader device 275 (e.g., a base station). For example, the first set of AIoT devices 280, including an AIoT device 280A, an AIoT device 280B, and an AIoT device 280C may be configured to, capable of, or operable to support DO-A operations (e.g., DO-A type data transmission). These AIoT devices 280 may be inventoried (e.g., known to) by the reader device 275, which may track or store the corresponding device IDs of the AIoT devices 280 (e.g., electronic product codes (EPCs)). The AIoT devices 280 may be equipped with sensors to perform measurements and collect sensor data (e.g., temperature data, humidity data, proximity data, motion data, air quality data (e.g., carbon dioxide data or other pollutants), water data, noise data, etc.) associated with the location 270.

One or more of the AIoT devices 280 may be associated with a device type. For example, each of the one or more AIoT devices 280 may be a Type 2B device (e.g., an active device). Additionally, each of the one or more AIoT devices 280 may be configured by the reader device 275 for DO-A type data transmission. For example, the reader device 275 may transmit, and each of the one or more AIoT devices 280 may receive, a configuration that indicates one or more of a channel access priority, a transmission priority, a data priority, or a combination thereof. In some examples, a high priority data may be associated with measurement and reporting of sensor data in response to (or based at least in part on) the sensor data (e.g., measured, collected) satisfying (e.g., being greater than or equal to) a threshold value. For example, high priority data may be sensor data, such as an air quality level (e.g., smoke level) that indicates that the air quality at the location 270 exceeds a threshold value (e.g., soot density) for the location 270. In some examples, medium priority data may be associated with periodic measurement and reporting of sensor. For example, periodic measurement and reporting of a temperature at the location 270, such as every 30 minutes. In some examples, low priority data may be associated with measurement and reporting of sensor data aperiodically or sporadically.

To manage (e.g., handle, control) traffic load associated with the AIoT devices 280 and/or to prioritize access attempts for the AIoT devices 280 configured for Do-A operations (e.g., DO-A type data transmission), the reader device 275 may manage access control for the AIoT devices 280 based at least in part on a type and/or priority of data collected and/or reported by the AIoT devices 280. For example, the reader device 275 or associated network may indicate (e.g., via a reader-to-device (R2D) message) to the AIoT devices 280 whether access is allowed or prohibited (e.g., not allowed) for high-priority data, medium-priority data, and/or low-priority data. In the example of FIG. 2B, the set of AIoT devices 290 may include one or more AIoT devices pending inventorying by the reader device 275. That is, these AIoT devices 290 have yet to be inventoried by the reader device 275 or associated network. In some cases, the set of AIoT devices 280 and/or the set of AIoT devices 290 may access the reader device 275 by performing a CBRA procedure, for example, a 3-step CBRA procedure based at least in part on a slotted Aloha/Q protocol, where a slot (also referred to as an access slot) is configured for each occasion (also referred to as access occasion) and a start of the slot is based on an access trigger command transmitted by the reader device 275 to the AIoT devices 280 and/or AIoT devices 290. For example, when CBRA is performed for DO-A type data transmissions based on the slotted Aloha/Q protocol, the reader device 275 may configure (e.g., via an R2D message) separate Q values based on a type and/or priority of DO-A data. An example configuration is as follows: small Q values for high-priority DO-A data, medium Q values for medium-priority DO-A data, and large Q values for low-priority DO-A data. The reader device 275 may configure (e.g., via an R2D message) separate frequency resources for DO-A type of data transmissions. The reader device 275 may transmit one or more messages (e.g., R2D messages), defined in protocol layers above an AIoT access stratum (AS) layer, to configure the AIoT devices 280. As described herein, Types 1/2A/2B AIoT devices may be configured for DO-A type data transmissions.

As described herein, a network (e.g., the reader device 275) may utilize various messaging flows when supporting DO-A type transmissions by one or more of the AIoT devices 280, 290. The network (e.g., the reader device 275) may support different messaging or data transmission scenarios, as described below.
Scenario 1: Mixed DO-DTT and DO-A data transmissions, where the reader device 275 allows and controls DO-A data transmission by one or more of the AIoT devices 280, 290 during a triggered inventory/command procedure. To avoid or mitigate coexistence problems with DO-DTT data transmissions for the triggered inventory/command procedure, the reader device 275 may trigger DO-A and DO-DTT data transmissions by separate R2D messages (e.g., for Msg3 transmission during a 3-step CBRA procedure). Thus, DO-A and DO-DTT data transmissions do not overlap in time. In some cases, the reader device 275 may separate the DO-A and DO-DTT data transmission using FDM (e.g., configuring different frequency resources for DO-A and DO-DTT).
Scenario 2: Standalone Do-A data transmissions, where one or more of the AIoT devices 280, 290 transmit corresponding DO-A data according to an access configuration command that is transmitted periodically by the reader device 275.
Scenario 3: Blind DO-A data transmissions, where one or more of the AIoT devices 280, 290 initiate a DO-A data transmission blindly to the reader device 275. The AIoT devices 280 may apply a random ID to a Msg1 of a CBRA procedure generated by each of the AIoT devices 280, 290 or predefined by the reader device 275. The AIoT devices 280, 290 may periodically transmit a Msg1 in response to (or based at least in part on) receiving a Msg2 from the reader device 275. The periodicity of the Msg1 transmission may be selected by the AIoT devices 280 based on implementation or be preconfigured by the reader device 275.

Following the above scenarios, a network (e.g., the reader device 275) may support DO-A types of data transmissions while avoiding problems due to coexisting with other data transmissions (e.g., within inventory or command procedures). Further, the network (e.g., the reader device 275) can configure AIoT devices 280, 290 data types and/or data priorities, and control/prioritize access attempts based on the configured data types or and/or data priorities.

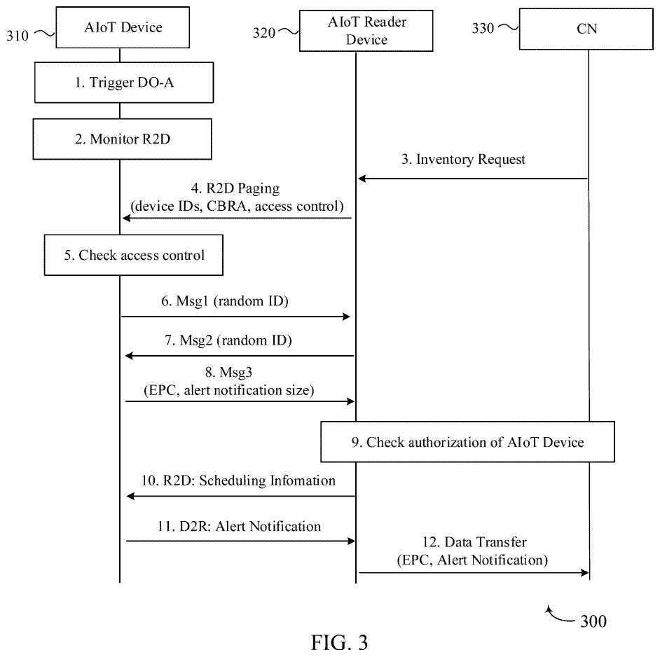

FIG. 3 illustrates an example diagram of a messaging flow 300 that supports AIoT device data transmission in accordance with aspects of the present disclosure. The messaging flow 300 may implement various aspects of the present disclosure described herein. For example, the messaging flow 300 may include an AIoT device 310, an AIoT reader device 320, and a CN 330 (e.g., at least one network entity of a CN, such as a 5GC or other network entity), which may be examples of AIoT devices, reader devices, and/or network entities of a CN, as described herein with reference to FIGS. 1, 2A, and 2B.

In the following description of the messaging flow 300, the operations and/or signaling between the AIoT device 310, the AIoT reader device 320, and the CN 330 may be performed or signaled (e.g., transmitted, received, backscattered) in different orders or at different times than the example order or times shown. Some operations and/or signaling may also be omitted, or other operations or signaling may be added. Although the AIoT device 310, the AIoT reader device 320, and the CN 330 are shown performing the operations of the messaging flow 300, some aspects of some operations may also be performed by other entities of the messaging flow 300 or by entities that are not shown in the messaging flow 300, or any combination thereof.

At step 1, the AIoT device 310 may trigger a DO-A operation (e.g., DO-A data transmission). For example, the AIoT device 310 may measure sensor data (e.g., air quality, such as smoke or other pollutant), determine that the measured sensor data satisfies (e.g., is greater than or equal to) a threshold, and trigger the DO-A operation. In this example, the DO-A operation may be a high-priority DO-A data transmission as described herein.

At step 2, the AIoT device 310 may monitor a channel or other wireless medium for one or more messages from the AIoT reader device 320. For example, the AIoT device 310 may monitor a downlink channel for one or more R2D messages from the AIoT reader device 320.

At step 3, the CN 330 may transmit, to the AIoT reader device 320, a request message for inventorying a set of AIoT devices. For example, at least one network entity of the CN 330 may transmit, and the AIoT reader device 320 (e.g., the reader device 275 as described herein with reference to FIG. 2B) may receive, an inventory request message for inventorying a set of AIoT devices (e.g., one or more AIoT devices 290 as described herein with reference to FIG. 2B). In some examples, the CN 330 may be a 5GC. It should be understood, however, that the CN 330 may support other technologies beyond 5G (e.g., such as 5G-A, 6G, etc.). The Inventory Request message may include a corresponding unique device IDs of each AIoT device of the set of AIoT devices (e.g., one or more AIoT devices 290 as described herein with reference to FIG. 2B).

At step 4, the reader device 320 may transmit, and the AIoT device 310 may receive, an R2D paging message. In some examples, the AIoT device 310 may include at least one of AIoT device of the set of AIoT devices 280 or the set of AIoT devices 290).

The R2D paging message may include a paging command for triggering an inventory procedure. The paging command may indicate one or more unique device IDs (e.g., of one or more target AIoT devices), one or more allocated CBRA resources (e.g., Q-value1 set to value 16, uplink frequency information for a Msg1, etc.) for DO-DTT data transmissions.

Additionally, or alternatively, the paging command may indicate a configuration for CBRA resources and access control for DO-A data transmissions. In the configuration, high-priority data transmission may be set to “allowed” (e.g., enabled), medium-priority data transmission may be set to “not allowed” (e.g., prohibited, disabled), and a Q parameter value (e.g., Q-value2) may be set to value 4 for DO-A high-priority data. In some cases, equivalent (e.g., same) frequency resource may be configured by the AIoT reader device 320 for the DO-A type and DO-DTT type of data transmission during the 3-step CBRA procedure, and the Msg1 transmissions may overlap in time.

At step 5, the AIoT device 310 may check an access control. In some examples, the AIoT device 310 may analyze the access control in response to (or based at least in part on) the received (e.g., detected) R2D paging message. The AIoT device 310 may determine that high-priority DO-A data transmissions is allowed, for example, based at least in part on the R2D paging message.

At step 6, the AIoT device 310 may initiates a 3-step CBRA procedure based at least in part on the Q-value2 and by transmitting a Msg1 to the AIoT reader device 320. The Msg1 may include a random ID generated by the AIoT device 310 during an access occasion.

At step 7, the AIoT reader device 320 may transmit, and the AIoT device 310 may receive, a Msg2. For example, the AIoT reader device 320 may receive the Msg1 and in response to the received Msg1 transmit the Msg2 to the AIoT device 310. In some examples, the Msg2 may include (e.g., indicate) the random ID received in the Msg1. In other words, in response to the reader device 320 receiving the Msg1 from the AIoT device 310, the AIoT reader device 310 may transmit and echo the received random ID in the Msg2.

At step 8, in response to (or based at least in part on) the received Msg2, the AIoT device 310 may transmit, and the AIoT reader device 320 may receive, a Msg3. The Msg3 may include an EPC associated with (e.g., identifies) the AIoT device 310 and a payload size of a triggered alert notification.

At step 9, in response to (or based at least in part on) the received Msg3, one or more of the AIoT reader device 320 or the CN 330 may determine whether the AIoT device 310 is authorized to transmit high-priority DO-A data. For example, the CN 330 may according to the EPC determine whether the AIoT device 310 is configured for high-priority DO-A transmission, ensuring that an authorized device is transmitting DO-A data to the AIoT reader device 320. If the AIoT device 310 is determined to be unauthorized, the AIoT reader device 320 may transmit a negative acknowledgement (NACK) to the AIoT device 310.

At step 10, based at least in part on the AIoT device 310 being authorized, the AIoT reader device 320 may transmit an R2D message to the AIoT device 310, including scheduling information (e.g., an uplink grant) for transmitting the high-priority data.

At step 11, the AIoT device 310 may transmit a device-to-reader (D2R) message including an alert notification to the AIoT reader device 320. For example, the D2R message may indicate the measured sensor data and/or that the measured sensor data satisfied (e.g., is greater than or equal to) the threshold as described at step 1.

At step 12, the AIoT reader device 320 may transmit a data transfer message to the CN 330, wherein the data transfer message includes the EPC of the AIoT device 310 and the received alert notification.

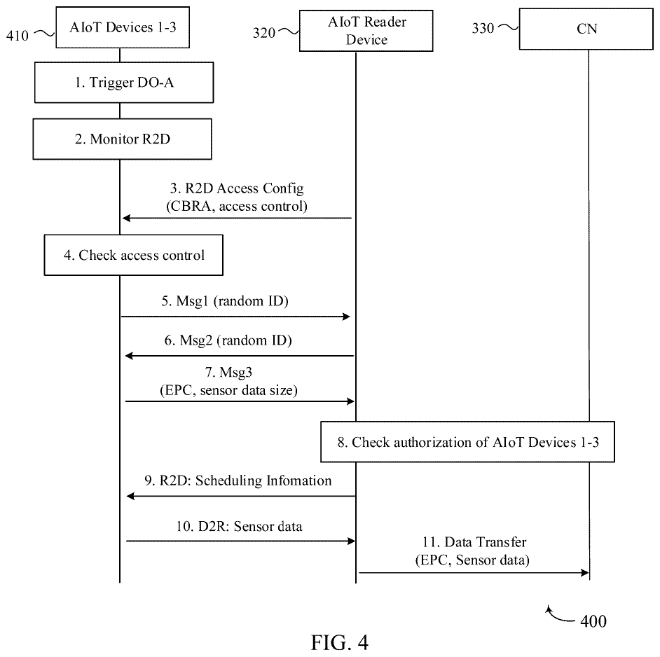

FIG. 4 illustrates an example diagram of a messaging flow 400 that supports device data transmission in accordance with aspects of the present disclosure. The messaging flow 400 may implement various aspects of the present disclosure described herein. For example, the messaging flow 400 may include AIoT devices 410, the AIoT reader device 320, and the CN 330, which may be examples of AIoT devices, reader devices, and/or network entities of a CN, as described herein with reference to FIGS. 1, 2A, and 2B.

In the following description of the messaging flow 400, the operations and/or signaling between the AIoT devices 410, the AIoT reader device 320, and the CN 330 may be performed or signaled (e.g., transmitted, received, backscattered) in different orders or at different times than the example order or times shown. Some operations and/or signaling may also be omitted, or other operations or signaling may be added. Although the AIoT devices 410, the AIoT reader device 320, and the CN 330 are shown performing the operations of the messaging flow 400, some aspects of some operations may also be performed by other entities of the messaging flow 400 or by entities that are not shown in the messaging flow 400, or any combination thereof.

At step 1, the AIoT devices 410 may trigger a DO-A operation (e.g., DO-A data transmission). For example, the AIoT devices 410 may measure sensor data based on a received configuration for DO-A data transmission and a medium-priority DO-A data transmission is triggered for each device, as described herein.

At step 2, the AIoT devices 410 may monitor a channel or other wireless medium for one or more messages from the AIoT reader device 320. For example, the AIoT devices 410 may monitor a downlink channel for one or more R2D messages from the AIoT reader device 320.

At step 3, to fetch DO-A data from the AIoT devices 410, the AIoT reader device 320 may transmit, and the AIoT devices 410 may receive, an R2D access configuration message. For example, the AIoT reader device 320 may periodically send an R2D message that contains an Access Config command (e.g., every Z seconds (e.g., 5, 10, 20, 60)). The Access Config command may contain a configuration for CBRA resources and access control for DO-A data transmissions, as follows: high-priority data transmission is set to “allowed” (e.g., enabled), medium-priority data transmission is set to “allowed” (e.g., enabled), Q-value1 is set to value 4 for DO-A high-priority data, and Q-value2 is set to value 16 for DO-A medium-priority data.

At step 4, the AIoT devices 410 may check an access control. In some examples, the AIoT devices 410 may analyze the access control in response to (or based at least in part on) the received (e.g., detected) R2D paging message. The AIoT devices 410 may determine that medium-priority DO-A data transmissions are allowed, for example, based at least in part on the R2D paging message.

At steps 5-7, each AIoT device of the AIoT devices 410 initiates, based on the received Q-value2, a 3-step CBRA procedure and by transmitting a Msg1 to the AIoT reader device 320. The Msg1 may include a random ID generated by the AIoT device during an access occasion.

The AIoT reader device 320 may transmit, and the AIoT devices 410 may receive, a Msg2. For example, the AIoT reader device 320 may receive the Msg1 and in response to the received Msg1 transmit the Msg2 to the AIoT devices 410. In some examples, the Msg2 may include (e.g., indicate) the random ID received in the Msg1. In other words, in response to the AIoT reader device 320 receiving the Msg1 from the AIoT devices 410, the AIoT reader device 310 may transmit and echo the received random ID in the Msg2. When the AIoT reader device 320 successfully receives the Msg1 from a device, it echoes the random ID in a Msg2. In response to (or based at least in part on) the received Msg2, each AIoT device may transmit, and the AIoT reader device 320 may receive, a Msg3. The Msg3 may include the EPC associated with the AIoT device and a payload size of the triggered sensor data.

At step 8, in response to (or based at least in part on) the received Msg3, one or more of the AIoT reader device 320 or the CN 330 may determine whether the AIoT device is authorized to transmit medium-priority DO-A data, as described herein. If any AIoT device is determined to be unauthorized, the AIoT reader device 320 may send a NACK to the respective AIoT device.

At step 9, based at least in part on each AIoT device being authorized, the AIoT reader device 320 may transit a R2D message to each of the AIoT devices 410, including scheduling information (e.g., an uplink grant) for transmitting the measured sensor data.

At step 10, the AIoT devices 410 may transmit a D2R message including measured sensor data to the AIoT reader device 320.

At step 11, the reader device 320 may transmit a data transfer message to the CN 330, where the data transfer message includes EPCs of the AIoT devices 410 and the received sensor data. In some cases, the AIoT reader device 320 may transmit the EPC and the sensor data from each AIoT device in a separate data transfer message to the CN 330.

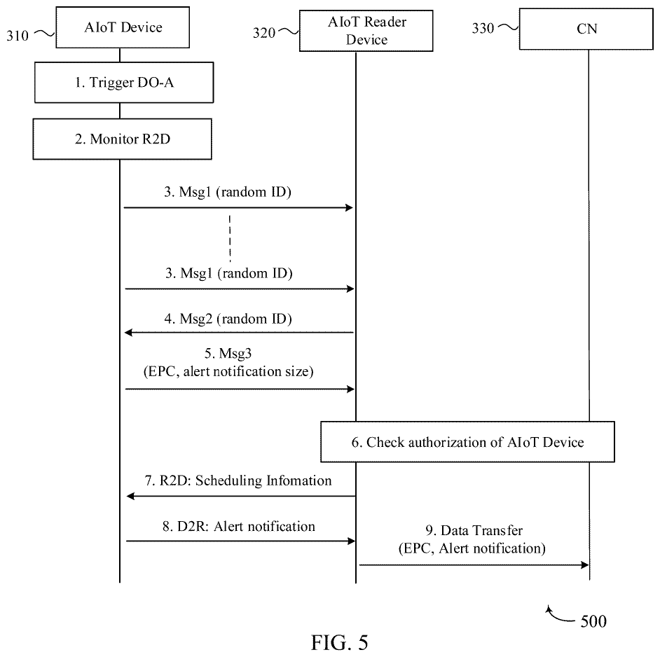

FIG. 5 illustrates another example diagram of a messaging flow 500 that supports AIoT device data transmission in accordance with aspects of the present disclosure. The messaging flow 500 may implement various aspects of the present disclosure described herein. For example, the messaging flow 500 may include the AIoT device 310, the AIoT reader device 320, and the CN 330, which may be examples of AIoT devices, reader devices, and/or network entities of a CN, as described herein.

In the following description of the messaging flow 500, the operations and/or signaling between the AIoT device 310, the AIoT reader device 320, and the CN 330 may be performed or signaled (e.g., transmitted, received, backscattered) in different orders or at different times than the example order or times shown. Some operations and/or signaling may also be omitted, or other operations or signaling may be added. Although the AIoT device 310, the AIoT reader device 320, and the CN 330 are shown performing the operations of the messaging flow 500, some aspects of some operations may also be performed by other entities of the messaging flow 500 or by entities that are not shown in the messaging flow 500, or any combination thereof.

At step 1, the AIoT device 310 may trigger a DO-A operation (e.g., DO-A data transmission). For example, the AIoT device 310 may measure sensor data (e.g., air quality, such as smoke or other pollutant), determine that the measured sensor data satisfies (e.g., is greater than or equal to) a threshold, and trigger the DO-A operation. In this example, the DO-A operation may be a high-priority DO-A data transmission as described herein.

At step 2, the AIoT device 310 may monitor a channel or other wireless medium for one or more messages from the AIoT reader device 320. For example, the AIoT device 310 may monitor a downlink channel for one or more R2D messages from the AIoT reader device 320.

At step 3, the AIoT reader device 320 is in an inactive state (e.g., a temporary sleep state), and the AIoT device 310 does not detect an R2D message from the AIoT reader device 320. The AIoT device 310 initiates a DO-A data transmission by sending (e.g., blindly) a Msg1. The Msg1 may include a random ID generated by the AIoT device 310. In some cases, the random ID to be used for blind high-priority access may be predefined by the AIoT reader device 320 or associated network. When the AIoT device 310 has sufficient energy, the AIoT device 310 periodically sends the Msg1 upon receipt a Msg2 from the AIoT reader device 320. In some case, the periodicity of the Msg1 transmission is based on an implementation or pre-defined by the reader device 320 or associated network entity (e.g., the CN 330)

At step 4, the AIoT reader device 320 is in an active state and receives the Msg1 from the AIoT device 310. The AIoT reader device 320 may transmit, and the AIoT device 310 may receive, a Msg2. For example, the AIoT reader device 320 may receive the Msg1 during the active state, and in response to the received Msg1 transmit the Msg2 to the AIoT device 310. In some examples, the Msg2 may include (e.g., indicate) the random ID received in the Msg1. In other words, in response to the AIoT reader device 320 receiving the Msg1 from the AIoT device 310, the AIoT reader device 310 may transmit and echo the received random ID in the Msg2.

At step 5, in response to (or based at least in part on) the received Msg2, the AIoT device 310 may transmit, and the AIoT reader device 320 may receive, a Msg3. The Msg3 may include an EPC associated with (e.g., identifies) the AIoT device 310 and a payload size of a triggered alert notification.

At step 6, in response to (or based at least in part on) the received Msg3, one or more of the AIoT reader device 320 or the CN 330 may determine whether the AIoT device 310 is authorized to transmit high-priority DO-A data. For example, the CN 330 may according to the EPC determine whether the AIoT device 310 is configured for high-priority DO-A transmission, ensuring that an authorized device is transmitting DO-A data to the AIoT reader device 320. If the AIoT device 310 is determined to be unauthorized, the AIoT reader device 320 may transmit a NACK to the AIoT device 310.

At step 7, based at least in part on the AIoT device 310 being authorized, the AIoT reader device 320 may transmit an R2D message to the AIoT device 310, including scheduling information (e.g., an uplink grant) for transmitting the high-priority data.

At step 8, the AIoT device 310 may transmit a D2R message including an alert notification to the AIoT reader device 320. For example, the D2R message may indicate the measured sensor data and/or that the measured sensor data satisfied (e.g., is greater than or equal to) a threshold.

At step 9, the AIoT reader device 320 may transmit a data transfer message to the CN 330, wherein the data transfer message includes the EPC of the AIoT device 310 and the received alert notification.

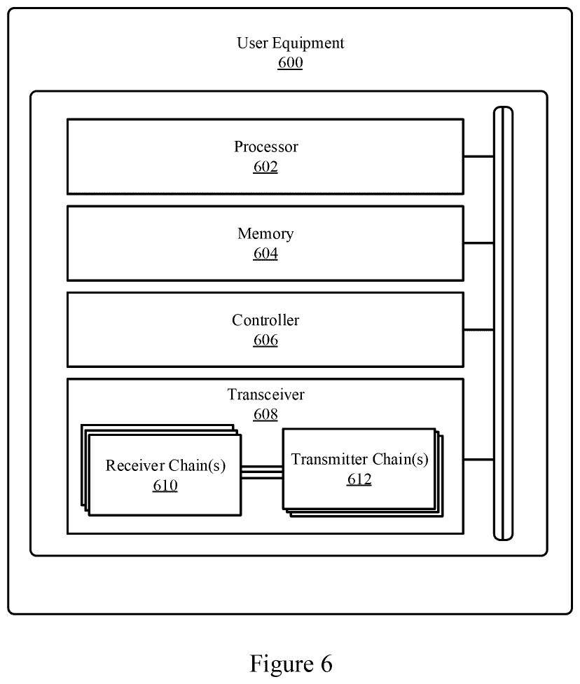

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to support a means for transmitting, to an IoT device, a first message comprising a set of one or more parameters for autonomous data transmission, and receiving, from the IoT device, a second message based at least in part on the transmitted first message.

As another example, the UE 600 may be configured to support a means for receiving, from a reader device, a first message comprising a set of one or more parameters associated with autonomous data transmission by the UE, determining an autonomous data transmission based on the set of one or more parameters, and transmitting, to the reader device, a second message based at least in part on the received first message.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium.

The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

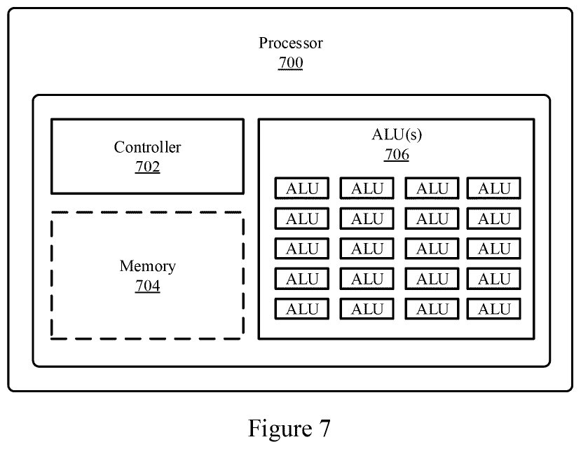

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The processor 700 may be configured to support a means for transmitting, to an IoT device, a first message comprising a set of one or more parameters for autonomous data transmission, and receiving, from the IoT device, a second message based at least in part on the transmitted first message.

In addition, the processor 700 may be configured to support a means for receiving, from a reader device, a first message comprising a set of one or more parameters associated with autonomous data transmission by the processor, determining an autonomous data transmission based on the set of one or more parameters, and transmitting, to the reader device, a second message based at least in part on the received first message.

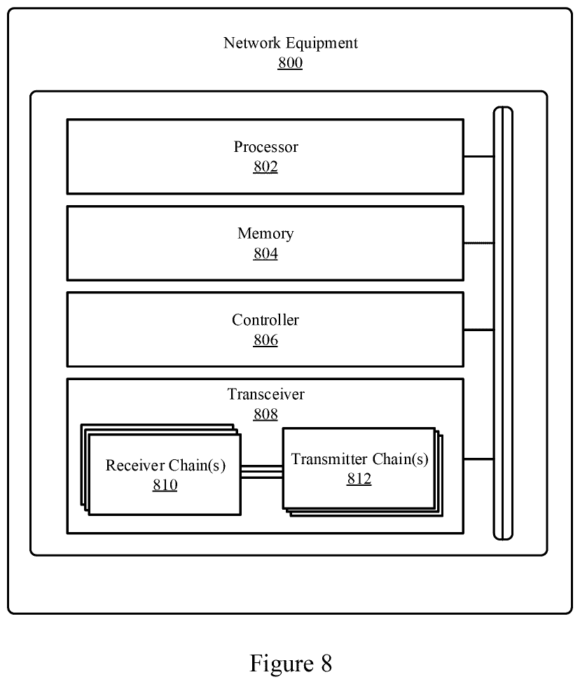

FIG. 8 illustrates an example of an NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to support a means for transmitting, to an IoT device, a first message comprising a set of one or more parameters for autonomous data transmission, and receiving, from the IoT device, a second message based at least in part on the transmitted first message.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receive the signal over the air or wireless medium.

The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

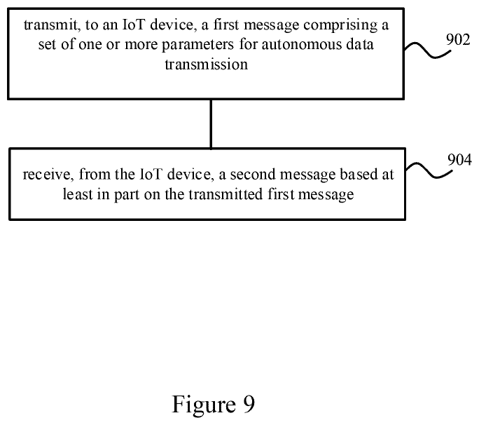

FIG. 9 illustrates a flowchart of a method in accordance with aspects of the present disclosure. The operations of the method may be implemented by a UE or NE as described herein (e.g., as a reader device). In some implementations, the UE or NE may execute a set of instructions to control the function elements of the UE or NE to perform the described functions.

At 902, the method may include transmitting, to an IoT device, a first message comprising a set of one or more parameters for autonomous data transmission. The operations of 902 may be performed in accordance with examples as described herein. In some implementations, aspects of the operations of 902 may be performed by a UE as described with reference to FIG. 6 or an NE as described with reference to FIG. 8.

At 904, the method may include receiving, from the IoT device, a second message based at least in part on the transmitted first message. The operations of 904 may be performed in accordance with examples as described herein. In some implementations, aspects of the operations of 904 may be performed by a UE as described with reference to FIG. 6 or an NE as described with reference to FIG. 8.

It should be noted that the method described herein describes a possible implementation, and that the operations and the steps may be rearranged or otherwise modified and that other implementations are possible.

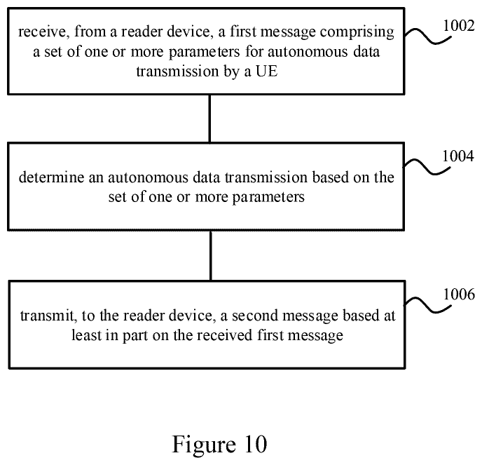

FIG. 10 illustrates a flowchart of a method in accordance with aspects of the present disclosure. The operations of the method may be implemented by a UE as described herein. In some implementations, the UE may execute a set of instructions to control the function elements of the UE to perform the described functions.

At 1002, the method may include receiving, from a reader device, a first message comprising a set of one or more parameters associated with autonomous data transmission by the UE. The operations of 1002 may be performed in accordance with examples as described herein. In some implementations, aspects of the operations of 1002 may be performed by a UE as described with reference to FIG. 6.

At 1004, the method may include determining an autonomous data transmission based on the set of one or more parameters. The operations of 1004 may be performed in accordance with examples as described herein. In some implementations, aspects of the operations of 1004 may be performed by a UE as described with reference to FIG. 6.

At 1006, the method may include transmitting, to the reader device, a second message based at least in part on the received first message. The operations of 1006 may be performed in accordance with examples as described herein. In some implementations, aspects of the operations of 1006 may be performed by a UE as described with reference to FIG. 6.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A reader device for wireless communication, comprising:
at least one memory; and
at least one processor coupled with the at least one memory and configured to cause the reader device to:
transmit, to an Internet of Things (IoT) device, a first message comprising a set of one or more parameters for autonomous data transmission; and
receive, from the IoT device, a second message based at least in part on the transmitted first message.

2. The reader device of claim 1, wherein the set of one or more parameters comprise a set of one or more values, and wherein each value indicates a corresponding priority associated with channel access for the IoT device during a contention-based random access (CBRA) procedure.

3. The reader device of claim 2, wherein the set of one or more values is based at least in part on a type of data for autonomous data transmission.

4. The reader device of claim 1, wherein the set of one or more parameters comprises a set of one or more values, and wherein each value indicates a probability for channel access for the IoT device during a contention-based random access (CBRA) procedure.

5. The reader device of claim 4, wherein the set of one or more values are based at least in part on a type of data for autonomous data transmission.

6. The reader device of claim 1, wherein the second message comprises an identifier of the IoT device.

7. The reader device of claim 6, wherein the at least one processor is further configured to cause the reader device to:
transmit, to the IoT device, a third message comprising scheduling information; and
receive, from the IoT device, a fourth message comprising information that indicates a type of collected data associated with the IoT device.

8. The reader device of claim 1, wherein the first message comprises a configuration that indicates:
one or more of a first set of time resources or a first set of frequency resources for autonomous data transmissions; and
one or more of a second set of time resources or a second set of frequency resources for trigger-based data transmissions.

9. The reader device of claim 8, wherein an autonomous data transmission is a sensor-based data transmission, and wherein a trigger-based data transmission is an inventory data transmission or a command data transmission.

10. The reader device of claim 1, wherein the at least one processor is further configured to cause the reader device to:
receive a third message from a second IoT device,
wherein the second message and the third message are received concurrently.

11. The reader device of claim 1, wherein the reader device is a user equipment (UE) or a base station.

12. A method performed by a reader device, the method comprising:
transmitting, to an Internet of Things (IoT) device, a first message comprising a set of one or more parameters for autonomous data transmission; and
receiving, from the IoT device, a second message based at least in part on the transmitted first message.

13. A user equipment (UE) for wireless communication, comprising:
at least one memory; and
at least one processor coupled with the at least one memory and configured to cause the UE to:
receive, from a reader device, a first message comprising a set of one or more parameters for autonomous data transmission by the UE;
determine an autonomous data transmission based on the set of one or more parameters; and
transmit, to the reader device, a second message based at least in part on the received first message.

14. The UE of claim 13, wherein the set of one or more parameters comprise a set of one or more values, and wherein each value indicates a corresponding priority associated with channel access for the UE during a contention-based random access (CBRA) procedure.

15. The UE of claim 14, wherein the set of one or more values is based at least in part on a type of data for autonomous data transmission.

16. The UE of claim 13, wherein the set of one or more parameters comprises a set of one or more values, and where each value indicates a probability for channel access for the UE during a contention-based random access (CBRA) procedure.

17. The UE of claim 16, wherein the set of one or more values are based at least in part on a type of data for autonomous data transmission.

18. The UE of claim 13, wherein the UE is an ambient Internet of Things (AIoT) device.

19. The UE of claim 13, wherein the at least one processor is further configured to cause the UE to:
collect information associated with an event at a location that contains the UE; and
transmit the collected information to the reader device based on an access prioritization identified by the set of one or more parameters.

20. A processor for wireless communication, comprising:
at least one controller coupled with at least one memory and configured to cause the processor to:
receive, from a reader device, a first message comprising a set of one or more parameters for autonomous data transmission by the processor;
determine an autonomous data transmission based on the set of one or more parameters; and
transmit, to the reader device, a second message based at least in part on the received first message.
